(19) United States
(12) Patent Application Publication
(10) Pub. No.: US 2014/0134889 A1
(43) Pub. Date: May 15, 2014

(54) UNIVERSAL SERIAL BUS RECEPTACLE AND UNIVERSAL SERIAL BUS PLUG WITH STRIP-LINE ARCHITECTURE

(71) Applicant: MEDIATEK INC., Hsin-Chu (TW)

(72) Inventors: Mao-Lin Wu, Hsinchu County (TW); Ho-Chung Chen, Taipei City (TW); Po-Sheng Kang, Hsinchu County (TW); Chieh-Chao Liu, Hsinchu City (TW); Chien-Chih Lee, Keelung City (TW)

(73) Assignee: MEDIATEK INC., Hsin-Chu (TW)

(21) Appl. No.: 13/916,595

(22) Filed: Jun. 13, 2013

Related U.S. Application Data
(60) Provisional application No. 61/756,039, filed on Jan. 24, 2013.
(60) Provisional application No. 61/724,444, filed on Nov. 9, 2012.
(60) Provisional application No. 61/758,360, filed on Jan. 30, 2013.

(51) Int. Cl. H01R 24/60

(52) U.S. Cl. CPC H01R 24/60
USPC 439/676

(57) ABSTRACT

A universal serial bus (USB) receptacle includes a core part and a conducting layer. The core part of the USB receptacle has a plurality of signal pads on a first side of the core part. The conducting layer is disposed on a second side of the core part of the USB receptacle. The second side of the core part of the USB receptacle is opposite to the first side of the core part. An associated USB plug is also provided. The USB plug includes a core part and a conducting layer. The core part of the USB plug has a plurality of signal pads on a first side of the core part of the USB plug. The conducting layer is disposed on a second side of the core part. The second side of the core part of the USB plug is opposite to the first side of the core part.

### CROSS REFERENCE TO RELATED APPLICATIONS

This application claims the benefit of U.S. Provisional Application No. 61/756,039 (filed Jan. 24, 2013), U.S. Provisional Application No. 61/724,444 (filed Nov. 9, 2012) and U.S. Provisional Application No. 61/758,360 (filed Jan. 30, 2013). The entire content of these related applications are incorporated herein by reference.

### BACKGROUND

Universal serial bus (USB) 3.0 or Super-Speed USB has a 5G bits/s signaling rate and requires data to be scrambled and applied to spread spectrum on the clock, meaning the USB 3.0 data spectrum could be ranging from DC to 5 GHz. That is, the noise radiated from the USB 3.0 cable or connector is high in the 2.4-2.5 GHz ISM (industrial, scientific and medical) band, which is an unlicensed radio frequency band widely used by standard protocols such as IEEE 802.11 b/g/n, Bluetooth, proprietary protocols, etc. The broadband interference noise emitted from a USB 3.0 interface can affect the signal-to-noise ratio (SNR) and limit the sensitivity of ISM RF throughput nearby.

In order to be compatible with USB 2.0 specification, mechanicals of a USB 3.0 connector will yield a longer return-current loop in response to the high-speed operations of the USB 3.0 connector. Nevertheless, common-mode currents distributed on the sheath of the USB 3.0 connector are prone to be the main factor of radiation. Traditionally, this problem is addressed by applying a shielding to the USB 3.0 peripheral devices or receptacle connectors. However, this shielding method can only bring mild improvement and is very hard to implement when it comes to compact devices.

There is a need, therefore, for an innovative solution to mitigate interference noises radiated from cables or connectors of a super-speed USB interface device.

### SUMMARY

In accordance with exemplary embodiments of the present invention, a universal serial bus (USB) receptacle and a USB plug are proposed to solve the above-mentioned problem.

According to a first aspect of the present invention, an exemplary USB receptacle is disclosed. The USB receptacle includes a core part and a conducting layer. The core part of the USB receptacle has a plurality of signal pads on a first side of the core part of the USB receptacle. The conducting layer is disposed on a second side of the core part of the USB receptacle. The second side of the core part of the USB receptacle is opposite to the first side of the core part of the USB receptacle.

According to a second aspect of the present invention, an exemplary USB plug is disclosed. The USB plug includes a core part and a conducting layer. The core part of the USB plug has a plurality of signal pads on a first side of the core part of the USB plug. The conducting layer is disposed on a second side of the core part of the USB plug. The second side of the core part of the USB plug is opposite to the first side of the core part of the USB plug.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a USB receptacle according to an embodiment of the present invention.

FIG. 2 is a schematic diagram illustrating the USB receptacle in FIG. 1 with another viewing angle according to an embodiment of the present invention.

FIG. 3 is a schematic diagram illustrating a USB plug according to an embodiment of the present invention.

FIG. 4 is a schematic diagram illustrating the USB plug in FIG. 3 with another viewing angle according to an embodiment of the present invention.

FIG. 5 is a schematic diagram illustrating a cross-section view of a USB receptacle engaged with a USB plug according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The present invention proposes a strip-line based architecture for a universal serial bus (USB) connecter in order to mitigate super-speed USB interface radiated interference noises. A concept of the present invention is to provide an additional conducting material applied to the opposite side of the USB signaling path as a return path of USB signals formed at a receptacle end and/or a plug end of the USB connecter. The applied conducting material on both the receptacle end and the plug end of the USB connecter will collaboratively form the strip-line architecture for the USB signaling path, thus mitigating the radiation introduced by common-mode current. Further details are provided as below.

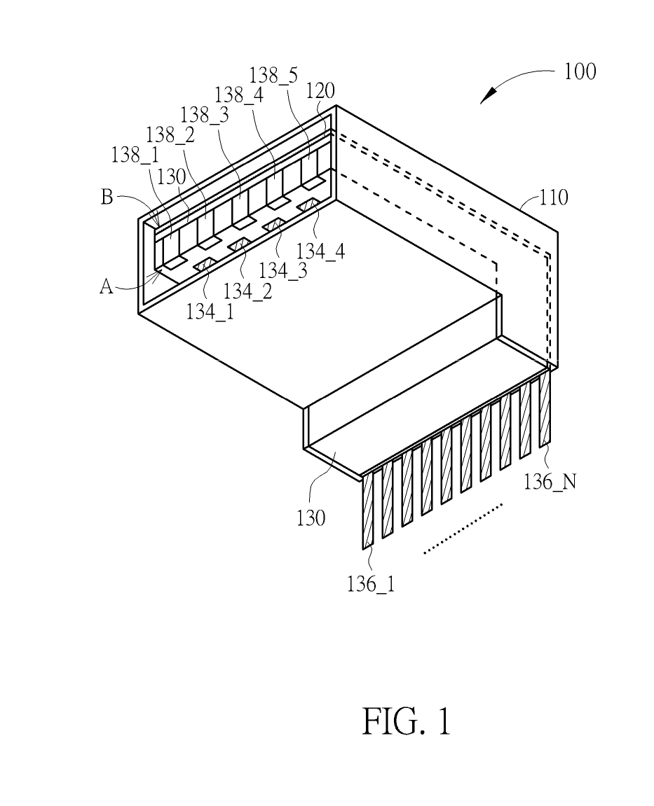

Please refer to FIG. 1, which is a schematic diagram illustrating a USB receptacle 100 according to an embodiment of the present invention. The USB receptacle 100 includes a metallic sheath 110, a conducting layer 120 and a core part 130. As can be seen from FIG. 1, the metallic sheath 110 encloses a space used to accommodate the conducting layer 120 and the core part 130. The metallic sheath 110 connects to a plurality of ground pads of a printed circuit board (not shown) on which the USB receptacle 100 is mounted. The space enclosed by the metallic sheath 110 is also arranged for adapting a counterpart workpiece (e.g., a USB plug). The core part 130 includes an insulating body 132, a plurality of metallic spring leaves 134_1-134_4, a plurality of pins 136_1-136_N, and a plurality of metallic contacts 138_1-138_5. The insulating body 132 includes a plurality of slots 1322_1-1322_4 on a first side A, and the metallic spring leaves 134_1-134_4 are disposed in the slots 1322_1-1322_4, respectively. The metallic spring leaves 134_1-134_4 are arranged for contacting a plurality of signal pads of the counterpart workpiece (e.g., a USB plug). The pins 136_1-136_N are embedded in the insulating body 132 and electronically connected with the metallic spring leaves 134_1-134_4 in the insulating body 132. The pins 136_1-136_N are arranged for connecting the printed circuit board (not shown) on which the USB receptacle 100 is mounted. The metallic contacts 138_1-138_5 are embedded in the insulating body 132 in front of the metallic spring leaves 134_1-134_4 and arranged for contacting a plurality of signal pads of the counterpart workpiece (e.g., a USB 3.0 plug). Also, the 136_1-136_N are electronically connected with the metallic spring leaves 138_1-138_5. The conducting layer 120 may be a metallic foil or sputtered conducting material disposed on a second side B of the core part 130. The second side B of the core part 130 is opposite to the first side A of the core part 130.

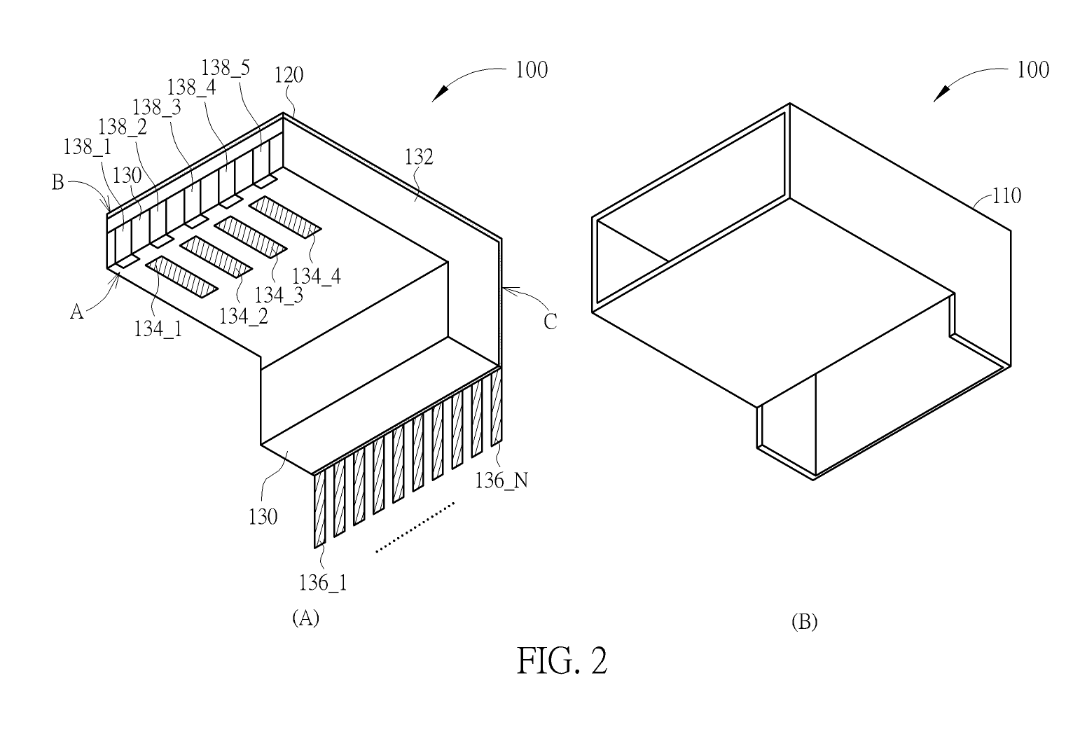

Please refer to FIG. 2, which is a schematic diagram illustrating the USB receptacle 100 with another viewing angle according to an embodiment of the present invention. In FIG. 2, the metallic sheath 110 shown in sub-diagram (B) is separated from the core part 130 shown in sub-diagram (A) for a better view of the conducting layer 120. As can be seen from FIG. 2, the conducting layer 120 covers the core part 130 on the second side B and a third side C. The third side C is a back side of the core part and is opposite to a receiving side of the USB receptacle 100 (i.e., the side on which the USB receptacle 100 and its counterpart workpiece meets). Since the second side B and the third side C are not coplanar, the conducting layer 120 bends at a joint of the second side B and the third side C of the core part 130. Besides, the conducting layer 120 on the side C of the core part 130 will contact the metallic sheath 110, and thus the conducting layer 120 and the metallic sheath 110 are electronically connected. Therefore, the conducting layer 120 on the opposite side of the metallic spring leaves 134_1-134_4 and 138_1-138_5 (i.e., the signaling path of the USB receptacle 100) may provide a return path for the USB signals on the metallic spring leaves 134_1-134_4 and 138_1-138-5. That is, the larger the coverage of the conducting layer 120 will provide the lower impedance of return path which would come out the better mitigation of radiation introduced by the common-mode current.

Please note that, the coverage of the conducting layer 120 should not exceed the perimeter of the metallic sheath 110. However, it is for illustrative purpose only, and not meant to be a limitation of the present invention. For example, the conducting layer 120 may only cover a part of the second side B and/or the third C as long as the conducting layer 120 is isomorphic and electronically connected to the metallic sheath 110. Since the distance between the conducting layer 120 and the metallic spring leaves 134_1-134_4 [symbol] 138_1-138-5 (i.e., the signaling path of the USB receptacle 100) is much closer than the distance between the metallic sheath 110 and the metallic spring leaves 134_1-134_4 [symbol] 138-1_138_5, the conducting layer 120 indeed provides a better return path than the metallic sheath 110 does. Besides, since the return path is provided by the conducting layer 120, an engineer may conduct an impedance control by changing attribute (s) of the conducting layer 120, such as length, width and/or applied conducting material. However, it is for illustrative purpose only, and not meant to be a limitation of the present invention.

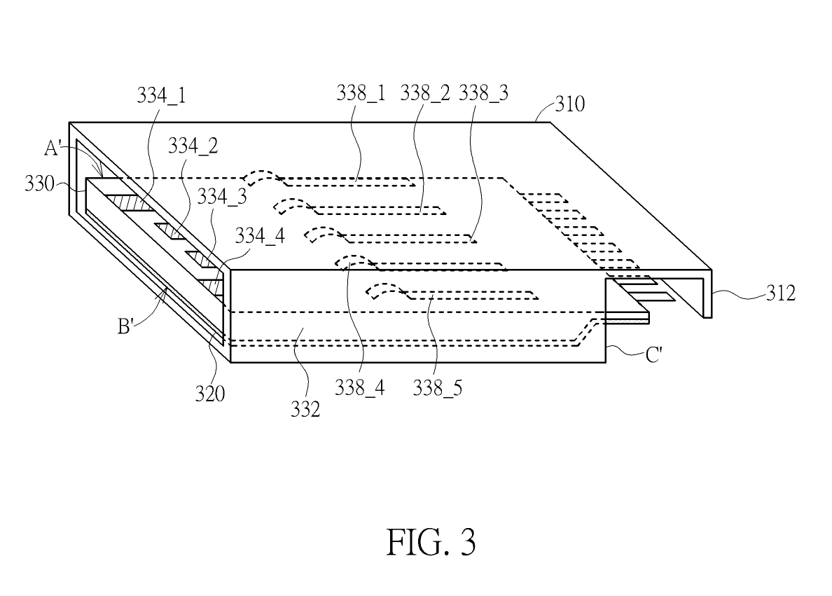

Please refer to FIG. 3, which is a schematic diagram illustrating a USB plug 300 according to an embodiment of the present invention. The USB plug 300 includes a metallic sheath 310, a conducting layer 320 and a core part 330. As can be seen from FIG. 3, the metallic sheath 310 encloses a space used to accommodate the conducting layer 320 and the core part 330. The metallic sheath 310 connects to a plurality of ground pads of a printed circuit board (not shown) on which the USB plug 300 is mounted. The space enclosed by the metallic sheath 110 is arranged for having connection with a counterpart workpiece (e.g., a USB receptacle). The core part 330 includes an insulating body 332, a plurality of signal pads 334_1-334_4, a plurality of pins 336_1-336_N, and a plurality of metallic spring leaves 338_1-338_5. The signal pads 334_1-334_4 and 338_1-338_5 are disposed on a first side A′ of the core part 330. The signal pads 334_1-334_4 and 338_1-338_5 are arranged for contacting a plurality of metallic spring leaves of the counterpart workpiece (e.g., a USB receptacle). The pins 336_1-336_N are embedded in the insulating body 332 and electronically connected with the signal pads 334_1-334_4 and 338_1-338_5 in the insulating body 332. The pins 336_1-336_N are arranged for connecting the printed circuit board (not shown) on which the USB plug 300 is mounted. The metallic spring leaves are embedded in the insulating body 332 behind the signal pads 334_1-334_4 [symbol] 338_1-338-5 and are arranged for contacting a plurality of metallic contacts of the counterpart workpiece (e.g., a USB 3.0 receptacle). The conducting layer 320 may be a metallic foil or sputtered conducting material disposed on a second side B′ of the core part 330, where the second side B′ of the core part 330 is opposite to the first side A′ of the core part 330.

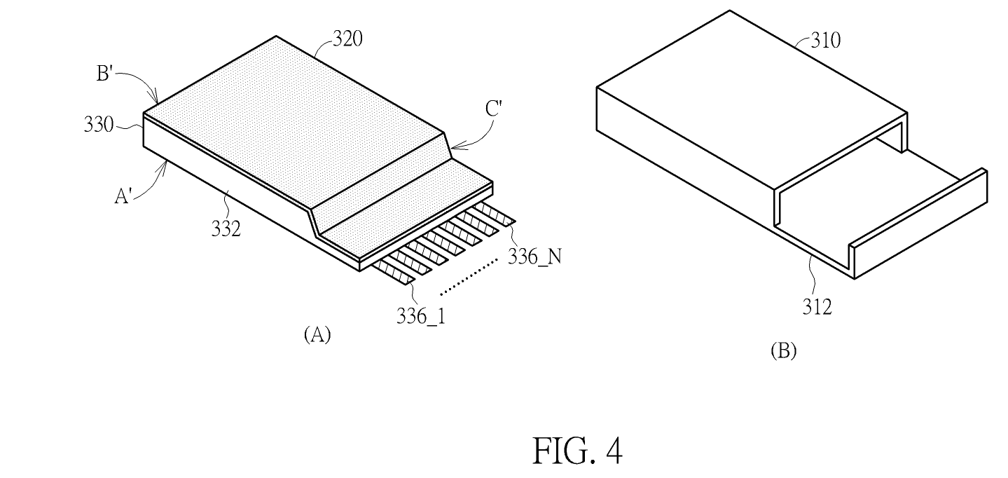

Please refer to FIG. 4, which is a schematic diagram illustrating the USB plug 300 with another viewing angle according to an embodiment of the present invention. In FIG. 4, the metallic sheath 310 shown in sub-diagram (B) is separated from the core part 330 shown in sub-diagram (A) for a better view of the conducting layer 320. As can be seen from FIG. 4, the conducting layer 320 covers the core part 330 on the second side B′. In addition, the conducting layer 320 on the side B′ of the core part 330 has contact with the metallic sheath 310, and thus the conducting layer 320 and the metallic sheath 310 are electronically connected. Please note that, the standoff between sheath 310 and conducting layer 320 could be adjusted for impedance control purpose. Therefore, the conducting layer 320 on the opposite side (i.e., the second side B′) of the signal pads 334_1-334_4 and 338_1-338_5 (i.e., the signaling path of the USB plug 300) may provide a return path for the USB signals on the signal pads 334_1-334_4 and 338_1-338_5. That is, the larger the coverage of the conducting layer 320, the lower impedance of return path which would come out the better mitigation of radiation introduced by the common-mode currents. Since the second side B′ of the core part 330 and the pins 336_1-336_N are not coplanar, the conducting layer 320 bends at a near end to the pins 336_1-336_N of the second side B′ and forms a beveled side C′ from the near end to the pins 336_1-336_N. Besides, the metallic sheath 310 includes an extension part 312 connected to the metallic sheath 310 on an opposite side to the side where the conducting layer 320 contacts the metallic sheath 310 at a near end to the pins 336_1-336_N. The extension part 312 covers an area where the conducting layer 320 extends to cover the pins 336_1-336_N. That is, the coverage of the conducting layer 320 should not exceed the perimeter of the metallic sheath 310. Please note that, since the return path is provided by the conducting layer 320, an engineer may conduct an impedance control by changing attribute(s) of the conducting layer 320, such as length, width and/or applied conducting material. However, it is for illustrative purpose only, and not meant to be a limitation of the present invention.

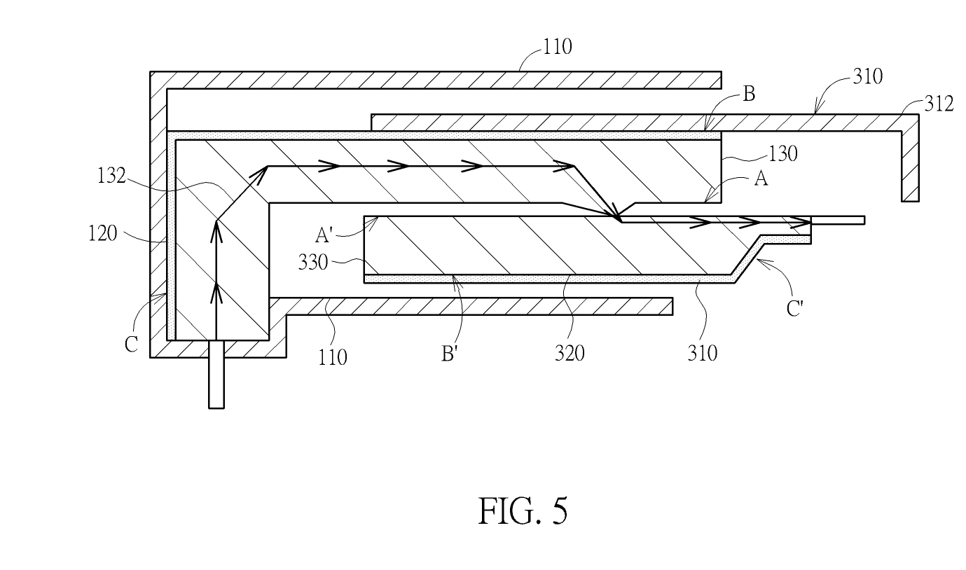

Please refer to FIG. 5, which is a schematic diagram illustrating a cross-section view of the USB receptacle 100 engaged with the USB plug 300 according to an embodiment of the present invention. As can be seen from FIG. 5, the conducting layer 120 and the conducting layer 320 collaboratively form the “strip-line based architecture” for the signal path (i.e., the arrowed line) of the USB connector (i.e., the USB receptacle 100 and the USB plug 300). The strip-line based architecture provides a more effective (lower impedance) return path and hence can significantly mitigate radiation noise. In addition, since the conducting layer 120 and the conducting layer 320 provides the return path, the sheath 110 and the sheath 310 are now act as a shield enclosing a signal transmission line and thus may provide a certain degree of shielding effect, which may also help mitigating noise radiation.

In sum, exemplary embodiments of the present invention provide a lower impedance return path. Therefore, the present invention can effectively mitigate interference noise for RF systems nearby without raising too much costs and altering too much mechanicals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A universal serial bus (USB) receptacle, comprising:
a core part, having a plurality of signal pads on a first side of the core part; and
a conducting layer, disposed on a second side of the core part, wherein the second side is opposite to the first side.

2. The USB receptacle of claim 1, wherein the conducting layer covers the entire second side of the core part and extends to cover a third side of the core part, the third side of the core part is opposite to a receiving side of the USB receptacle; and the conducting layer bends at a joint of the first side and the third side.

3. The USB receptacle of claim 2, further comprising:
an external metallic sheath, connected to a printed circuited board on which the USB receptacle is mounted;
wherein the conducting layer on the third side is within a perimeter of the external metallic sheath.

4. The USB receptacle of claim 3, wherein the conducting layer electronically connects to the external metallic sheath on the third side of the core part.

5. A universal serial bus (USB) plug, comprising:
a core part, having a plurality of signal pads on a first side of the core part; and
a conducting layer, disposed on a second side of the core part, wherein the second side is opposite to the first side.

6. The USB plug of claim 5, further comprising:
an external metallic sheath, comprising:
an extension part, connected to the external metallic sheath on an opposite end of a receiving end of the USB plug;
wherein the extension part covers an area where the conducting layer extends to cover the plurality of pins.

7. The USB receptacle of claim 6, wherein the extension part bends toward a printed circuit board on which the USB plug is mounted.

8. The USB receptacle of claim 6, wherein the extension part is metallic.
